(19) United States
(12) Patent Application Publication
(10) Pub. No.: US 2023/0095178 A1
(43) Pub. Date: Mar. 30, 2023

(54) TOOL FOR REPEATEDLY FEEDING INDIVIDUAL FASTENING ELEMENTS FROM A SUPPLY OF A PLURALITY OF FASTENING ELEMENTS

(71) Applicant: Airbus Operations GmbH, HAMBURG (DE)

(72) Inventors: Jörn SKIRKE, HAMBURG (DE); Wolfgang PAPENDICK, HAMBURG (DE)

(21) Appl. No.: 17/953,408

(22) Filed: Sep. 27, 2022

(30) Foreign Application Priority Data
Sep. 29, 2021 (EP) 21199821.6

(51) Int. Cl. B21J 15/32

(52) U.S. Cl. CPC B21J 15/32; B21J 15/022

(57) ABSTRACT

A tool for repeatedly feeding individual fasteners from a fastener supply includes a receiver, a guide, a flexible, linear thruster, an electric drive, an activator, and a feeder with a dispenser. The guide extends along a curved guide track from the receiver into the feeder and terminates at the dispenser. Along the guide track the guide has a substantially constant opening cross section radially defined by a guide element relative to the guide track to guide the fasteners directly adjacent to one another along the guide track. The thruster extends from the receiver into the guide and has an external cross section adapted to the opening cross section and configured to be moved in a guided manner by the drive in the guide along the guide track. The drive is coupled to the activator and moves the thruster in the direction of the dispenser when the activator is actuated.

### CROSS-REFERENCES TO RELATED APPLICATIONS

This application claims the benefit of the European patent application No. 21199821.6 filed on Sep. 29, 2021, the entire disclosures of which are incorporated herein by way of reference.

### FIELD OF THE INVENTION

The present description relates to a tool for repeatedly feeding individual fastening elements from a supply of a plurality of fastening elements.

### BACKGROUND OF THE INVENTION

In the mass production of larger technical devices, for example vehicles, a plurality of screw connections or rivet connections may be regularly produced. In vehicles, for example aircraft, occasionally working processes may be present in which several hundred lock washer bolt connections have to be produced one after the other. These connections may comprise attaching lock washer bolts, a lock washer being positioned thereon. Feed devices are known for positioning lock washers or other fastening elements, in which the fastening elements are provided one after the other to a feed device by means of compressed air and also held in position on the feed device. Such a device is disclosed, for example, in U.S. Pat. No. 9,511,416 B2.

The use of compressed air-operated tools may be disadvantageous. A compressed air source is required, which leads to a certain development of noise. Moreover, the tool has to be connected via a compressed air hose which may impair the handling.

Electric tools are increasingly used in modern production environments such that an infrastructure for compressed air-operated tools is sometimes not present in such an environment.

### SUMMARY OF THE INVENTION

It may be regarded as an object to propose an alternative tool which permits a convenient dispensing of individual fastening elements from a plurality of fastening elements which are present in a receiving container, wherein the tool does not have to be supplied with power, however, via a compressed air hose.

A tool for repeatedly feeding individual fastening elements from a supply of a plurality of fastening elements is proposed, the tool comprising a receiving container, a guide device, a flexible, linear thrust element, an electric drive, an activation element, and a feed element with a dispensing portion, wherein the guide device adjoins the receiving container and extends therefrom into the feed element and terminates at the dispensing portion, wherein the guide device runs at least in some sections along a curved guide track, wherein along the guide track the guide device has a substantially constant opening cross section which is radially defined by at least one guide element relative to the guide track in order to guide a plurality of fastening elements directly adjacent to one another along the guide track, wherein the thrust element extends from the receiving container into the guide device and has an external cross section which is adapted to the opening cross section and which is configured to be guided in the guide device along the guide track, wherein the electric drive is coupled to the thrust element and is configured to displace the thrust element incrementally along the guide track in order to urge the fastening elements arranged in the guide device to the dispensing portion, and wherein the drive is coupled to the activation element and is configured to move the thrust element by a predeterminable distance in the direction of the dispensing portion when the activation element is actuated.

As a result, the tool according to the invention is configured to provide individual fastening elements, one after the other, on a dispensing portion of a feed element. These fastening elements are to be used by a user for carrying out an assembly activity. Thus, the tool may preferably be a hand-held tool, or an end effector on a robot, which is provided with a suitable plurality of fastening elements. The purpose of the tool according to the invention is to provide individual fastening elements reliably, repeatedly and in a simple manner, without requiring elaborate manual interaction and without the necessity for a compressed air line.

The individual fastening elements are directly mounted in the guide device. In this case, the guide device is to be understood as a serpentine-shaped component which extends along a curved movement path and preferably has a substantially uniform cross section for receiving the individual fastening elements. The fastening elements are arranged therein such that they form a chain-like structure and are positioned in abutment with one another. The number of fastening elements which are present in the guide device may be influenced according to the activity to be carried out. If the tool according to the invention is used, for example, for providing lock washers which are positioned onto the shank of a lock washer bolt, several hundred such fastening elements could be stored in the tool to cover the requirements of a working day. The guide device could accordingly have a longitudinal extension which significantly exceeds a diameter or a different width dimension.

In this case, the movement path could be designed in a helical manner, and at least substantially circulate around a specific helix diameter. In a filled state, the entire guide device is preferably filled with fastening elements which extend in abutment with one another from an internal end, or a position in the vicinity of the internal end, of the guide device to the dispensing portion.

The thrust element is provided in order to convey the fastening elements along the guide device. This thrust element is designed to be flexible such that it is inserted into the guide device at the internal end, then it may be displaced along the guide device and at the same time adapts its shape to the movement track. If the thrust element moves via the electric drive in the direction of the dispensing portion, the thrust element urges the entire chain consisting of individual fastening elements in the direction of the dispensing portion. If a fastening element is removed from the dispensing portion, a gap is immediately produced on the dispensing portion. By a subsequent movement of the thrust element, the remaining fastening elements are moved by a distance which corresponds to the maximum length of the gap which is present. After the removal of the outermost fastening element, the thrust element may consequently be moved in order to provide on the dispensing portion a new fastening element which is to be removed therefrom.

Since the thrust element is inserted to different distances in the guide device, depending on the number of fastening elements still remaining, the remaining part is mounted in the receiving container. Due to the flexibility, the thrust element is folded, wound or compacted in a different manner therein.

The feed element could be configured as a straight or curved arm which protrudes from the tool and terminates in the dispensing portion. It is advantageous to implement a design which is as ergonomic as possible and in which a user may guide the tool, which is held by hand, onto the corresponding component in order to be able to dispense the fastening element there.

The dispensing portion may be designed in the manner of conventional tools which are based on the use of compressed air. This means that the relevant fastening element is presented on the dispensing portion such that it may be positioned on a corresponding component or may be fastened in a different manner without having been previously removed. If the fastening element is a lock washer, for example, the dispensing portion could be configured such that an opening of the lock washer is freely accessible from the outside, such that the lock washer may be directly positioned on a lock washer bolt while it still rests in the dispensing portion.

The movement of the fastening elements to the dispensing portion may be initiated by the activation element. The activation element does not necessarily have to be a manual switch which is actuated by a user, wherein this is entirely conceivable, however. As variant, one or more sensors which activate the drive when a specific event has been established could be considered. This could occur automatically, for example, if a fastening element had been removed from the dispensing portion and a gap produced therein. If the tool is arranged as an end effector on a robot arm, the activation element could also be designed externally from the tool and could be represented by an activation signal. If the robot arm moves after a connection is produced, a control unit could output an activation signal which causes the tool to move the thrust element.

The tool according to the invention may thus be used in the manner of the known tools based on compressed air, for repeatedly feeding fastening elements without having to rely on a compressed air line. It is also conceivable to provide the tool with a rechargeable electrical energy storage device which permits an autonomous operation and significantly improves the handling, by eliminating the compressed air line and a supply cable.

It is advantageous if the thrust element is substantially incompressible. As a result, the thrust element may be urged into the guide device in order to be adapted therein to the guide track in terms of its shape but without being compressed. As a result, the material of the thrust element is prevented from being bulged out locally and being twisted or wedged in the guide device.

The thrust element could be configured as a chain with a plurality of chain links which are connected together in an articulated manner. The chain links could comprise, for example, a metal material or a plastics material having a sufficient strength Similar to the case of a bicycle chain, for example, the individual chain links are preferably pivotably mounted on one another substantially without play. As a result, the chain is incompressible and at the same time flexible.

The electric drive could have a stepper motor. A stepper motor is characterized by a controllable electromagnetic field of the stator coils rotating in a stepwise manner. This permits the stepper motor to rotate incrementally in a very accurate manner. As a result, the thrust element may be positioned particularly carefully, since the drive of the thrust element may be adapted accurately to the fastening element.

The thrust element could have a length which exceeds the length of the guide device. Thus, a part of the thrust element may remain outside the guide device and may be coupled there to the drive. As a result, the thrust element may still be driven even when only a single fastening element is in the guide device, since then the thrust element could still protrude sufficiently far out of the guide device that the drive is able to be coupled to this portion.

The receiving container could be configured to receive the thrust element at least substantially entirely. If the guide device is entirely filled with fastening elements, the thrust element marginally protrudes into the guide device. As a result, a significant part of the thrust element is outside the guide device and to this end is received by the receiving container. Due to its flexible shape, the thrust element may be folded up and mounted therein in a space-saving manner.

The electric drive could have an engagement element which is able to be brought into engagement with the thrust element. The engagement element could comprise, for example, a gear wheel, a chain wheel, a friction element or the like, which is able to convert, in particular, a rotational drive into a linear drive of the thrust element. In this case, the engagement element is adapted to the design of the thrust element.

The electric drive could be arranged on an internal end of the guide device which opposes the dispensing portion. As a result, the guide device is independent of the electric drive such that, for example, a simple removal of the guide device is possible. The drive and the thrust element are then arranged in a region of the tool which remains in place when a guide device is replaced.

The tool could further comprise a sensor for detecting the thrust element, wherein the sensor is arranged on the feed element and is configured to output a signal which represents an exhausted supply of fastening elements when the thrust element is identified in the feed element. As a result, the tool is automatically able to prevent the further movement of the thrust element and/or to provide an indication to a user that the supply is exhausted or shortly before it is to be exhausted. The sensor could either be arranged directly on the dispensing portion or could be slightly spaced apart therefrom such that a relevant part of the thrust element may be identified before it reaches the dispensing portion.

The thrust element could have a magnet element, wherein the sensor is a Hall sensor which is configured to output the signal when the magnet element is directly placed on the sensor. The magnet element is very easily identified by a Hall sensor so that the magnet element may be used as a simple and effective marking.

The drive could be configured to move the thrust element entirely into the receiving container when the guide device is empty, wherein at least the guide device is configured as a replaceable magazine. As a result, the thrust element is moved into a safe neutral position before the guide device is replaced as a magazine. This significantly simplifies the handling and additionally prevents damage to the thrust element.

The guide device could be arranged in a magazine housing which may be connected to the receiving container. The housing encases the curved guide device and may protect this guide device. Additionally, the magazine housing is preferably provided with a suitable closure which permits a simple attachment or removal of the magazine housing.

The activation element could have a manually actuatable switch button. As a result, the user may actuate the switch button in order to position the next fastening element on the dispensing portion.

The invention further relates to a fastening system comprising a tool as described above, with a plurality of connecting elements and a plurality of fastening elements, wherein the connecting elements have a shank, the fastening elements being able to be pushed or positioned thereon, and wherein the fastening elements are arranged in the guide device of the tool. The connecting elements may be a lock washer bolt, for example, while the fastening elements are lock washers. The fastening elements are then arranged in the guide device and may be provided in a very rapid and reliable manner in the case of larger lock washer bolt connection arrangements.

### BRIEF DESCRIPTION OF THE DRAWINGS

The exemplary embodiments are described in more detail hereinafter with reference to the accompanying drawings. The views are schematic and not to scale. The same reference numerals refer to elements which are the same or similar. In the drawings:

FIGS. 1a to 1c show a schematic view, in addition to detailed views of a tool according to an exemplary embodiment.

FIG. 2 shows a schematic view of the working principle.

FIG. 3 shows a detailed view of the tool.

### DETAILED DESCRIPTION OF THE PREFERRED EMBODIMENTS

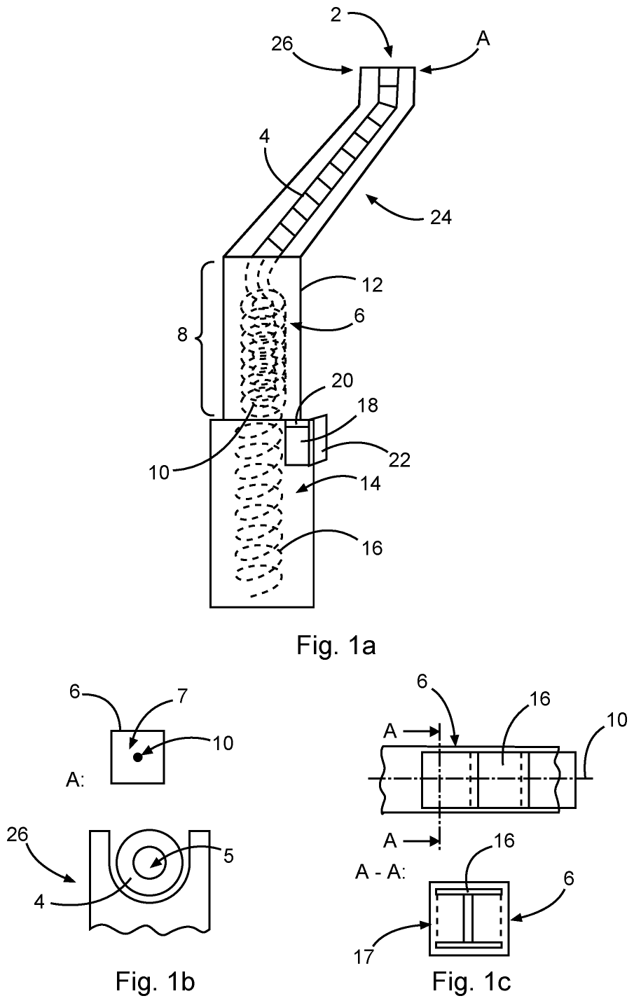

FIG. 1a shows a tool 2 for repeatedly feeding individual fastening elements 4 from a supply of a plurality of fastening elements 4. The fastening elements 4 may be, for example, lock washers which may be positioned, in each case, on the shank of a lock washer bolt.

The tool 2 has a guide device 6 which runs in a first portion 8 along a curved guide track 10 such that a substantially helical structure results here. As a result, a long running length is provided, the fastening elements 4 being arranged in abutment with one another along the running length. The guide device 6 is partially encased by a magazine housing 12 and may be fastened therein. The combination of the guide device 10 and the magazine housing 12 forms a magazine which may be easily replaced.

The guide device 6 adjoins a receiving container 14 in which a thrust element 16 is located. The thrust element 16 is flexible and configured in a linear manner or linearly. The thrust element is designed such that it may be inserted into the guide device 6 and is movable therein in a linear manner along the guide track 10. The thrust element 16 could be configured as a chain which may be driven by means of a drive 18 which, in this case, comprises an engagement element 20 designed as a chain wheel. An activation element 22 could be provided, the activation element being configured to activate the drive 18 by actuation, in order to move the thrust element 16 and the fastening elements 4.

A feed element 24, as an elongated protruding arm, adjoins an end of the guide device 6 remote from the drive 18 and has a dispensing portion 26. The fastening elements 4 are conveyed in the guide device 6 along the feed element 24 toward the dispensing portion 26 where they may then be removed individually.

A fastening element 4 in the form of a lock washer which rests in the dispensing portion 26 is shown in the detail A. An internal opening 5 is accessible from the outside, such that when the fastening element 4 is presented it is able to be positioned onto a lock washer bolt 25 as a connecting element, as shown in FIG. 1a in detail, such that the tool 2 is moved away from the lock washer bolt after the fastening element has been positioned.

FIG. 1b shows by way of example the guide device 6 in a section perpendicular to the movement track 10, which is shown here in the center. The guide device 6 has an internal cross section 7 which is defined by guide elements 9, for example walls surrounding the internal cross section 7. As shown in FIG. 1c, an external cross section 17 of the thrust element 16 is adapted to the internal cross section 7 such that it may be easily moved therein. The thrust element 16 is shown here as a chain which comprises a plurality of chain links 15 which are connected together in an articulated manner.

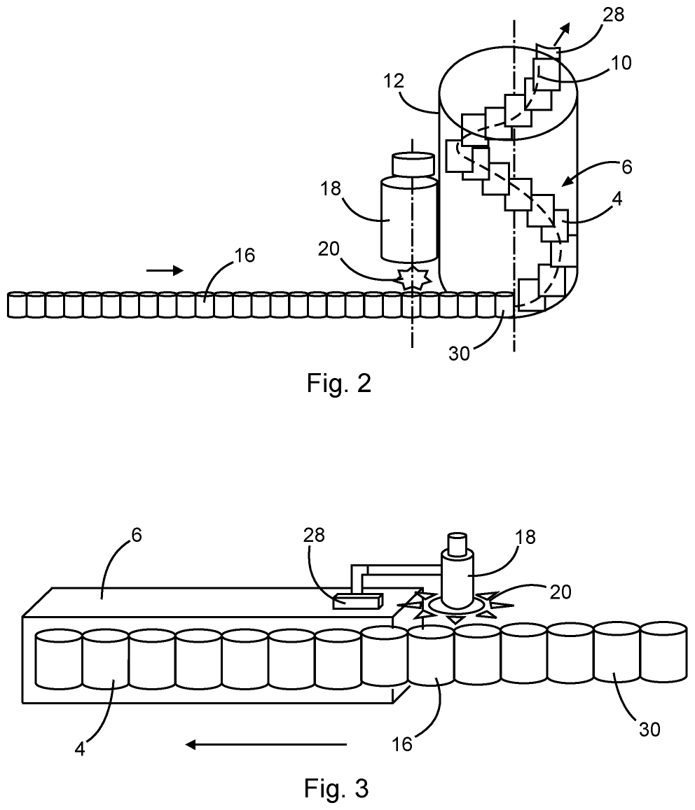

It is schematically shown in FIGS. 2 and 3 how the thrust element 16 extends into the guide device 6 and conveys fastening elements 4 in the direction of the dispensing portion 26. The engagement element 20 is driven by the electric drive 18 and moves the thrust element 16 in the guide device 6, such that the fastening elements which are present in abutment therein are displaced. If the drive 18 is designed as a stepper motor, the movement may be controlled in a very accurate manner.

A sensor 28, which is designed here as a Hall sensor, is provided on an end of the magazine housing 12 facing the dispensing portion 26. It is conceivable to provide the thrust element 16 with a magnet 30 such that the sensor 28 may detect this magnet as soon as the thrust element reaches the sensor 28. As a result, a signal which displays that the supply of fastening elements 4 is almost used up may be initiated.

In addition, it should be mentioned that “comprising” or “having” does not exclude any other elements or steps and “one” or “a” does not exclude a plurality.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE NUMERALS

2 Tool
4 Fastening element/lock washer
6 Guide device
7 Internal cross section
8 First portion
9 Guide element
10 Guide track
12 Magazine housing
14 Receiving container
15 Chain link
16 Thrust element
17 External cross section
18 Drive
20 Engagement element
22 Activation element
24 Feed element
25 Connecting element/lock washer bolt
26 Dispensing portion
28 Sensor
30 Magnet

1. A tool for repeatedly feeding individual fastening elements from a supply of a plurality of fastening elements, comprising:
a receiving container
a guide device,
a flexible, linear thrust element,
an electric drive,
an activation element, and
a feed element with a dispensing portion,
wherein the guide device adjoins the receiving container and extends therefrom into the feed element and terminates at the dispensing portion,
wherein the guide device runs at least in some sections along a curved guide track,
wherein along the guide track, the guide device has a substantially constant opening cross section which is radially defined by at least one guide element relative to the guide track to guide a plurality of fastening elements directly adjacent to one another along the guide track,
wherein the thrust element extends from the receiving container into the guide device and has an external cross section which is adapted to the opening cross section, and which is configured to be guided in the guide device along the guide track,
wherein the electric drive is coupled to the thrust element and is configured to displace the thrust element incrementally along the guide track to urge the fastening elements arranged in the guide device to the dispensing portion, and
wherein the drive is coupled to the activation element and is configured to move the thrust element by a predeterminable distance in a direction of the dispensing portion when the activation element is actuated.

2. The tool according to claim 1, wherein the thrust element is substantially incompressible.

3. The tool according to claim 1, wherein the thrust element is configured as a chain with a plurality of chain links which are connected together in an articulated manner.

4. The tool according to claim 1, wherein the electric drive has a stepper motor.

5. The tool according to claim 1, wherein the thrust element has a length which exceeds the length of the guide device.

6. The tool according to claim 1, wherein the receiving container is configured to receive the thrust element at least substantially entirely.

7. The tool according to claim 1, wherein the electric drive has an engagement element which is able to be brought into engagement with the thrust element.

8. The tool according to claim 1, wherein the electric drive is arranged on an internal end of the guide device which opposes the dispensing portion.

9. The tool according to claim 1, further comprising a sensor for detecting the thrust element, wherein the sensor is arranged on the feed element and is configured to output a signal which represents an exhausted supply of fastening elements when the thrust element is identified in the feed element.

10. The tool according to claim 9,
wherein the thrust element has a magnet element, and
wherein the sensor is a Hall sensor which is configured to output the signal when the magnet element is directly placed on the sensor.

11. The tool according to claim 1,
wherein the drive is configured to move the thrust element entirely into the receiving container when the guide device is empty, and
wherein at least the guide device is configured as a replaceable magazine.

12. The tool according to claim 11, wherein the guide device is arranged in a magazine housing which may be connected to the receiving container.

13. The tool according to claim 1, wherein the activation element has a manually actuatable switch button.

14. A fastening system, comprising:
a tool according to claim 1,
a plurality of connecting elements, and
a plurality of fastening elements,
wherein the connecting elements have a shank, the fastening elements being able to be pushed or positioned thereon, and
wherein the fastening elements are arranged in the guide device of the tool.
